(19) United States
(12) Patent Application Publication
(10) Pub. No.: US 2019/0128562 A1
(43) Pub. Date: May 2, 2019

(54) COMPRESSOR PAD AND METHOD OF FABRICATION

(71) Applicant: Rectorseal, LLC, Houston, TX (US)

(72) Inventors: Zhengyi Xu, Houston, TX (US); Harvey Steven Grodjesk, Houston, TX (US)

(21) Appl. No.: 16/110,057

(22) Filed: Aug. 23, 2018

Related U.S. Application Data
(60) Provisional application No. 62/707,262, filed on Oct. 26, 2017.

(51) Int. Cl. F24F 13/32; F16M 5/00

(52) U.S. Cl. CPC F24F 13/32; F16M 2200/08; F16M 5/00

(57) ABSTRACT

An improved prefabricated pad for supporting an air-conditioning compressor outdoors and the method of fabricating same is disclosed. The supporting pad comprises a shell defining an interior cavity in which is located a core member. The core member is affixed within the cavity and may include a protective layer with various insecticides and related products. The combined shell and core member creates an integral unit having the strength and rigidity to support an air-conditioning compressor or similar unit. The method of manufacturing same using steam injection and expanded polystyrene beads is also disclosed, as well as other types of foam source material.

### CROSS REFERENCE TO RELATED APPLICATION

This application claims priority to U.S. Provisional Patent Application Ser. No. 62/707,262, filed Oct. 26, 2017, and entitled “HVAC Pad”, of which the entire content of U.S. Provisional Patent Application Ser. No. 62/707,262 is hereby incorporated by reference and made a part hereof.

### FIELD OF THE INVENTION

The present invention relates generally to a pad for supporting a compressor and the method of fabricating same. More particularly, the present invention relates to an improved prefabricated pad for supporting an air-conditioning compressor outdoors and the method of fabricating same.

### BACKGROUND OF THE INVENTION

Air-conditioning compressors are typically located outdoors. This can be an issue since it is important to keep the compressor level and elevated off the ground for multiple reasons. Conventional moveable pads for supporting an outside air-conditioning compressor are typically a solid concrete square or rectangle pad, a concrete pad with cavities to reduce weight, a cementitious shell covering a lighter interior material, a solid plastic pad, or a plastic pad with cavities. These pads are satisfactory in performing their function, but even the lighter weight pads of the prior art can be heavier than contractors installing the units desire. Hence, the need exists for a lighter and more durable moveable pad to support an outdoor air-conditioning compressor.

### SUMMARY OF THE INVENTION

In order to provide a lighter and more durable movable pad to support an outdoor air-conditioning compressor, the present invention comprises a shell member having a top side and a plurality of descending sides. The top side has a top surface and a bottom surface, and each descending side is attached along one edge of the descending side to the top side. In this manner, a cavity is formed below the bottom surface of the top side and the interior surfaces of the descending sides. At least one protrusion member extends from the bottom surface of the top side into the cavity. The present invention also includes a core member, preferably a foam member in a cuboid shape having a top surface, a bottom surface, and a plurality of side surfaces. The core member is affixed within the cavity and held in place by the protrusion member. It may be advantageous to shape the core member such that there is a gap between at least one interior surface of a descending side and one side surface of the core member to accommodate manufacturing tolerances. Additionally, it may be advantageous to use an adhesive between the bottom surface of the top side of the shell and the top surface of the core member to further adhere the core member within the cavity. In order to strengthen the descending sides, the shell member may be fabricated with one or more indentions or ribs in each side.

In an alternate embodiment of the present invention, the descending sides may extend below the bottom surface of the core member. In this manner, such portions of the descending sides extending below the bottom of the core member may be heated and then wrapped around the edge of the core member to further retain the core member in place.

In yet an alternate embodiment, the core member may include an insecticide, a termiticide, for a rodenticide to inhibit insects or rodents from transferring past the core member or chewing on the core member. The insecticide, termiticide, or rodenticide may be sprayed onto the core member or infused within the core member during the manufacturing process. If the core member is made of foam such infusion would occur when the foam member is being manufactured.

The present invention also comprises a manufacturing process to create the supporting pad. Such a process comprises forming a shell member, preferably composed of plastic, wherein the shell member includes a top side, having a top surface and a bottom surface, and a plurality of descending sides, each having an interior side and an exterior surface. Preferably, the shell member is fabricated with one or more protrusion members descending from the bottom surface into the cavity formed below the bottom surface of the top side and the interior side surfaces of the descending sides. The next step comprise the forming of a foam member within the shell member. Preferably, the foam member is made of expanded polystyrene (EPS) which is injected into the shell using steam. The foam is permitted to cure within the shell until dry. In such a manner the foam member is embedded within the cavity around the protrusion member(s) and held in place.

The steps of forming the shell and the foam member may be done sequentially or concurrently. If done concurrently, the shell would be formed in the bottom portion of a mold and then EPS beads injected into the mold under pressure using steam as the medium.

The manufacturing process may also include having a portion of one or more descending sides extending below the bottom surface of the foam member which then requires a heating step and then a folding step to bend such portion of the descending side around the bottom edge of the foam member.

In the manufacturing process, the foam member may be manufactured of ESP foam as noted above. Alternatively, it may be made of extruded polystyrene (XPS) or polyisocyanurate (ISO). It may also be preferable in certain instances to use polyurethane if it is desirable to have an open cell foam structure. If a closed cell foam structure is preferred it may be advantageous to use polyethylene.

Other and further objects, features, and advantages of the present invention will be apparent from the following description of the present invention, given for the purpose of disclosure, and taken in conjunction with the accompanying drawings.

### BRIEF DESCRIPTION OF THE DRAWINGS

FIG. 1(a) is a top view of the shell member of the present invention.

FIG. 1(b) is an isometric view of the top surface of the shell member of the present invention.

FIG. 1(c) is an isometric view of the bottom surface of the shell member of the present invention.

FIG. 1(d) is a side view of the shell member of the present invention.

FIG. 1(e) is a cross-sectional view taken along line A-A of FIG. 1(d) of the shell member of the present invention.

FIG. 2 is an isometric view of the core member of the present invention.

FIG. 2(a) is a detailed view of the bottom side of the core member showing the protective layer(s) of the present invention.

FIG. 3 is a bottom view of the assembled present invention showing the core member within the shell member.

FIG. 3(a) is a detailed view of a corner of assembled present invention showing the core member within the shell member.

FIG. 4(a) is a bottom view of the bottom surface of an alternate embodiment of the shell member having a portion of each descending side that extends below the core member once the core member of the present invention is inserted therein.

FIG. 4(b) is a bottom view of the present invention showing the portions of the descending sides that extend below the core member.

FIG. 4(c) is a detail of a corner of the alternate embodiment of the present invention showing the portions of the descending sides below the core member bent over the core member edges to further retain the core member within the shell member.

FIG. 5 is a schematic illustrating the manufacturing process of the present invention.

### DETAILED DESCRIPTION OF THE PREFERRED EMBODIMENTS

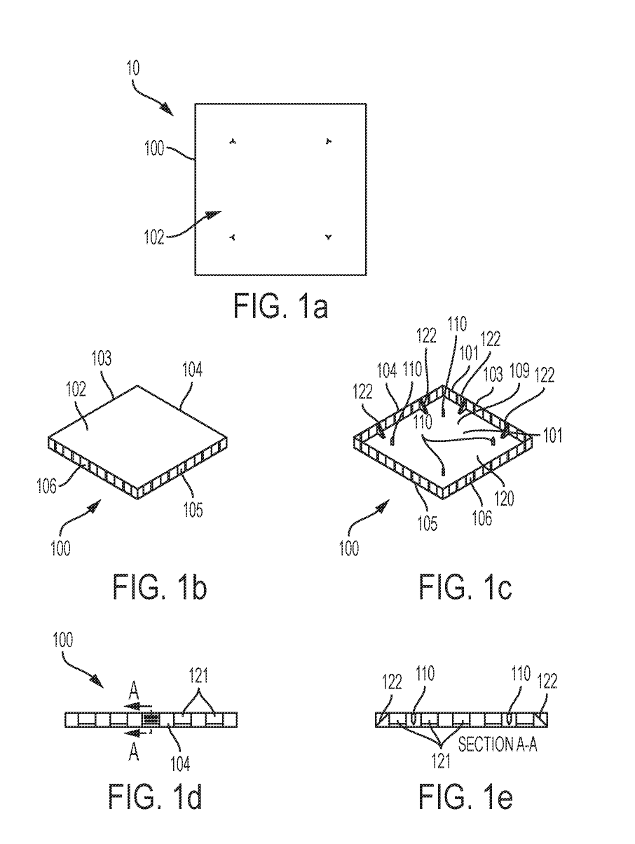

Referring now to FIGS. 1(a)-(c), the present invention is a supporting pad 10 used to support an outdoor air-conditioning compressor. Referring to FIG. 1(a), pad 10 comprises a shell 100. In FIG. 1(a), shell 100 is shown in a top view having a top side 101 with a top surface 102. Referring to FIG. 1(b), shell 100 further comprises descending sides 103, 104, 105, and 106. FIG. 1(c) is an isometric bottom view of shell 100 showing a bottom surface 109 of top side 101. Bottom surface 109 and sides 103-106 form a cavity 120.

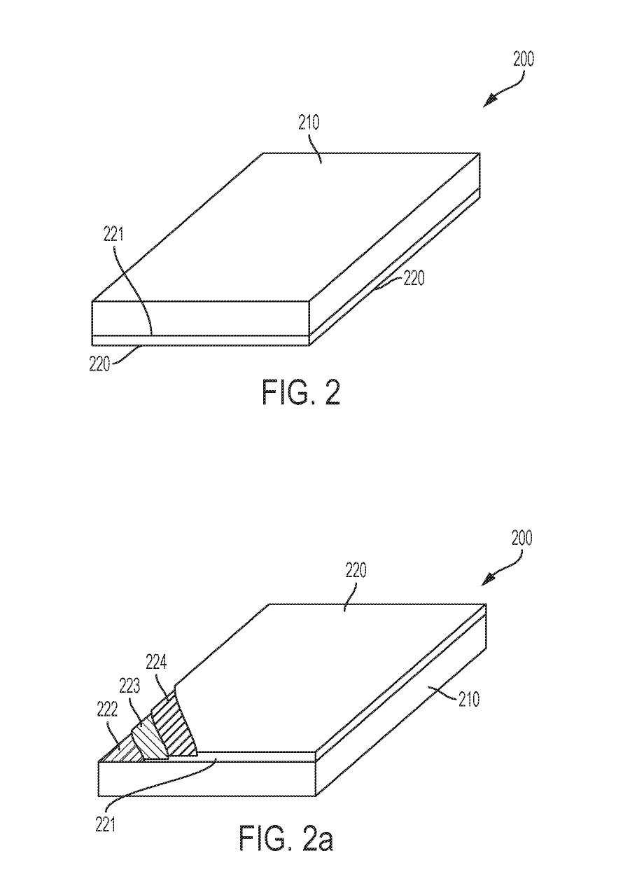

Referring still to FIG. 1(c), protrusion members 110 extend from the bottom surface 109 into cavity 120. Protrusion members 110 are intended to penetrate a core member 200 as shown in FIG. 2 when inserted within cavity 120. As shown, four protrusion members 110 extend from bottom surface 109 into cavity 120. Such protrusion members 110 may be, for example, a nail, spike, screw, wedge shaped member and it may be an integral part of top side 101 of shell 100 when shell 100 is manufactured or protrusion members 110 may be attached to top side 101 after shell 100 has been manufactured. Protrusion members 110 may have serrated edges to engage core member 200 preventing it from being pulled out of cavity 120. Preferably there is at least one protrusion member 110, more preferably at least three protrusion members 110, and most preferably at least four protrusion members 110. Each protrusion member 110 would extend between 0.5 and 3 inches into cavity 120 depending on the height of sides 103-106. In addition to attaching core member 200 within shell 100 using protrusion members 110, it may be advantageous to use adhesives such as a polyurethane adhesive or other hot melt adhesive, or a combination of both, to further secure core member 200 within cavity 120.

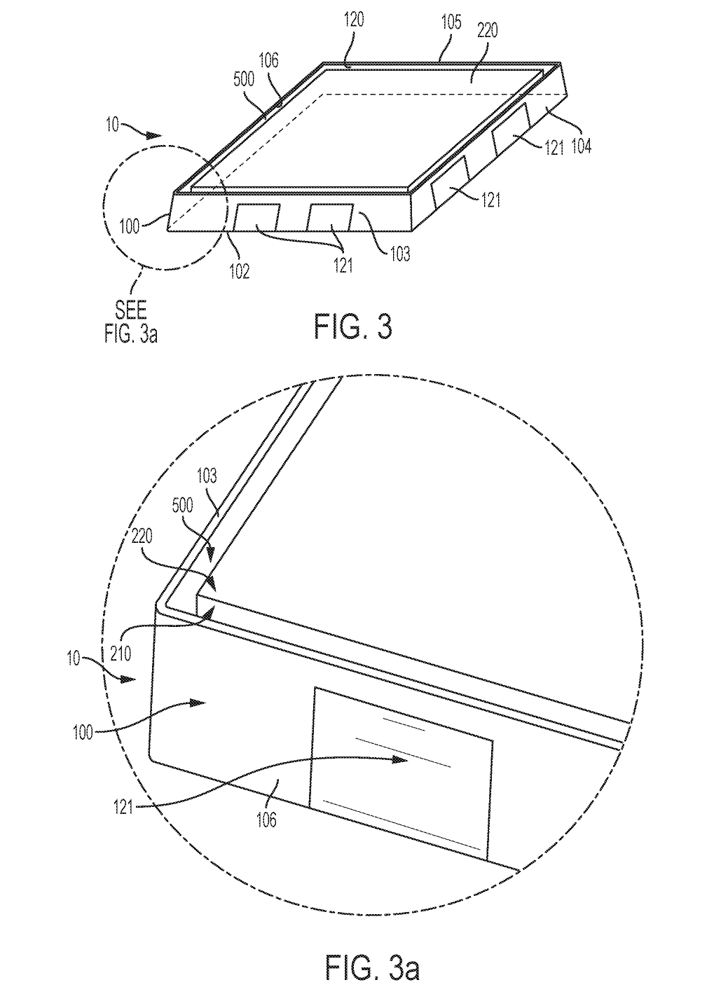

Referring now to FIGS. 1(d)-(e), side 104 is shown in the side view of FIG. 1(d). Side 104, and each other side 103 and 105-106 may include indentions 121 (see FIG. 3), created during the manufacture of shell 100. Indentions 121 serve to make the corresponding side 103-106 more rigid and therefore less likely to bend or warp. Additionally, such indentions 121 provide some irregularity on the inside surface of each side 103-106 which may provide some additional affixation basis to retain core member 200 within cavity 120. Alternatively, ribs 122 may be used instead of indentions 121 or in addition to them. Preferably ribs 122 are an integral part of each side 103-106, typically created when shell 100 is manufactured. Preferably ribs 122 extend inwardly into cavity 120. In this manner, ribs 122 serve to strengthen each side 103-106 and also to provide an additional device to embed within core member to further adhere core member within cavity 120.

FIG. 1(e) is also a side view of shell 100 but taken along line A-A of FIG. 1(d). This figure shows protrusion members 110 extending downwardly into cavity 120 and an interior view of indentions 121 and ribs 122.

Preferably, shell 100 is manufactured of plastic and molded to have a top side 101, sides 103-106 with indentions 121 and protrusion members 110, all as described above. Such manufacturing techniques generating molded plastic shapes are well known to those skilled in the art. Shell 100 may be manufactured from a number of different plastics such as polypropylene or polyethylene. Preferably, the thickness of plastic shell 100 is between about 0.05 inches and about 0.25 inches, more preferably between about 0.075 inches and about 0.125 inches, and most preferably between about 0.08 inches and about 0.1 inches.

Alternatively, shell 100 may be fabricated of other materials such as metal, wood or composite material, well known to those skilled in the art, so long as the teachings of this disclosure are incorporated.

Referring now to FIG. 2, core member 200 is shown in isometric view. Core member 200 is preferably comprised of a cuboid-shaped core member 210, although core member 200 may comprise more than six faces depending on the corresponding shape of cavity 120. Core member 200 is sized and shaped so that it fits into cavity 120. That is, core member 200 has overall dimensions (i.e. length, width and height) similar to the interior surfaces of shell 100 defining cavity 120.

Preferably core member 200 is made of a foam, and more preferably of polystyrene, although it can be any of a number of different types of foam such as polyisocyanurate, polyurethane, or polyethylene, or a composite made, for example, from light weight concrete and an open cell foam such as polyurethane so that the concrete saturates the foam during manufacture of the core member. In at least one embodiment, core member 200 is Styrofoam® which is available commercially from StarRFoam of Arlington, Tex., www.starrfoam.com.

Referring still to FIG. 2, a protective layer 220 may be attached to the bottom side 221 of core member 210 using an adhesive layer or an adhesive glue, well known to those skilled in the art. Protective layer 220 is designed to protect core member 210 when pad 10 is deployed on an outside ground surface to support an air-conditioning compressor or other equipment. While protective layer 220 is intended to protect core member 210 from exposure to the ground when pad 10 is deployed, layer 220 may also be used to improve the appearance of bottom side 221 of core member 200 by giving it a desired color.

Referring now to FIG. 2(a), protective layer 220 may be used, for example, to add an insecticide 222, termiticide 223 or rodenticide 224 protection to core member 210. In some embodiments insecticide 222, termiticide 223, and/or rodenticide 224 is simply sprayed or applied to the bottom side 221 of core member 210. It may be a film or coating such as a polymer. In at least one embodiment it may be a plastic film available commercially from ADLAM Films of Shannon, Miss., www.adlamfilms.com, and is attached to core member 210 by an adhesive. In other embodiments protective layer 220 can be attached to core member 210 in any of a number of different ways including roll brush. In other embodiments, if core member 210 is made of foam, the termiticide, rodenticide and/or insecticide is infused into the foam during the manufacture of the core member 210 or it is applied to the foam beads prior to the formation of the foam as discussed below.

Referring now to FIGS. 3 and 3(a), the bottom side of shell 100 is shown with core member 210 firmly embedded within cavity 120 of shell 100. FIG. 3(a) is a detailed view of a corner of bottom side 221 of core member 210 inserted within cavity 120. Preferably sides 103-106 of shell 100 are tapered slightly outwardly leaving a gap 500 between core member 210 and the interior surfaces 226 of sides 103-106. Preferably, gap 500 is present around the entire perimeter of core member 210. Gap 500 is between about 0.05 inches and about 0.20 inches. Gap 500 is important because it allows air movement when core member 210 is inserted within cavity 120 of shell 100 during the manufacture of pad 10. In addition, gap 500 allows for alignment errors between core member 210 and the interior surfaces 226 of sides 103-106 during the assembly phase of pad 10.

Referring still to FIG. 3(a), indentions 121 of sides 103-106 are also shown. As mentioned above, indentions 121 serve to make the corresponding sides 103-106 more rigid and, therefore, less likely to bend or warp.

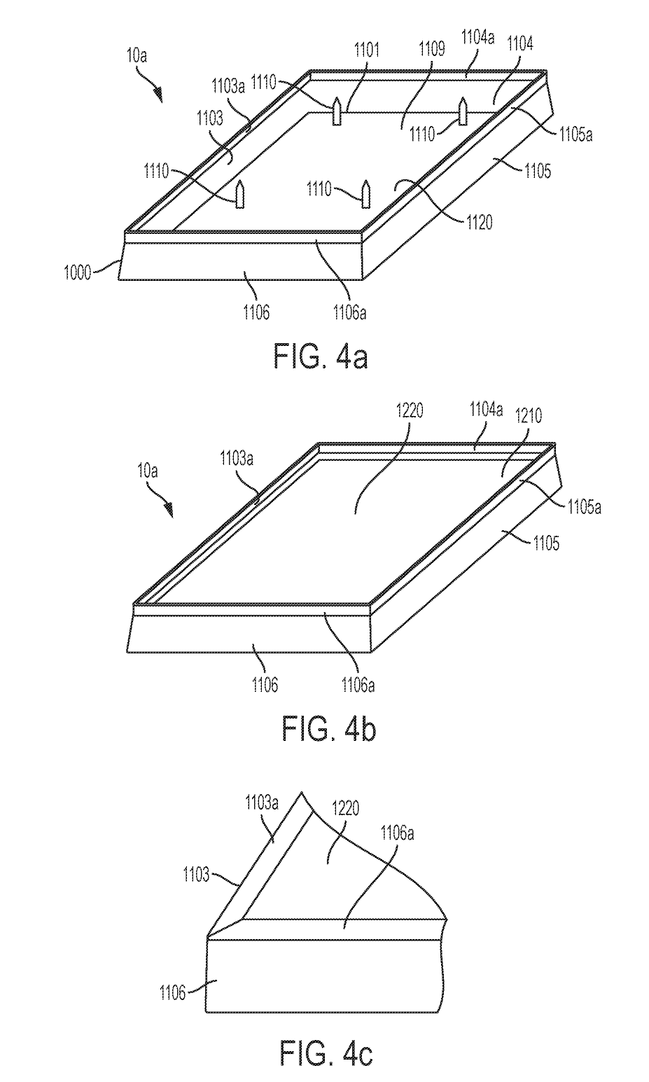

Referring now to FIGS. 4(a)-(c), an alternate embodiment of the present invention is shown, reflecting a pad 10a used to support an air-conditioning compressor outdoors. Pad 10a comprises a shell 1000 having a top side 1101. Referring to FIG. 4(a), a bottom surface 1109 of top side 1101 is shown. Shell 1000 also includes descending sides 1103-1106. Each side 1103-1106 includes a corresponding upper portion 1103a-1106a. Referring to FIG. 4(b) core member 1210 is shown inserted within cavity 1120 defined by top side 1101 and sides 1103-1106. Portions 1103a-1106a of each corresponding side 1103-1106 extends above bottom side 1221 of core member 1210. In this manner, once core member 1210 is inserted within cavity 1120, portions 1103a-1106a may be heated and then folded over the edges of core member 1210 as shown in FIG. 4(c), thereby retaining core member 1210 within cavity 1120 of shell 1000.

Additionally, this alternate embodiment may also include protrusion members 1110, as discussed above, in various embodiments such as a nail, screw, or other wedge member, which further serves to retain core member 1210 within cavity 1120 of shell 1000. Furthermore, core member 1210 may be retained within cavity 1120 by an adhesive as discussed above.

In addition, a protective layer 1220 may also be placed on the bottom side 1221 of core member 1210. As discussed above, such a protective layer may be an insecticide, termiticide, and/or a rodenticide, either applied mechanically by painting or with an adhesive layer, all as discussed above.

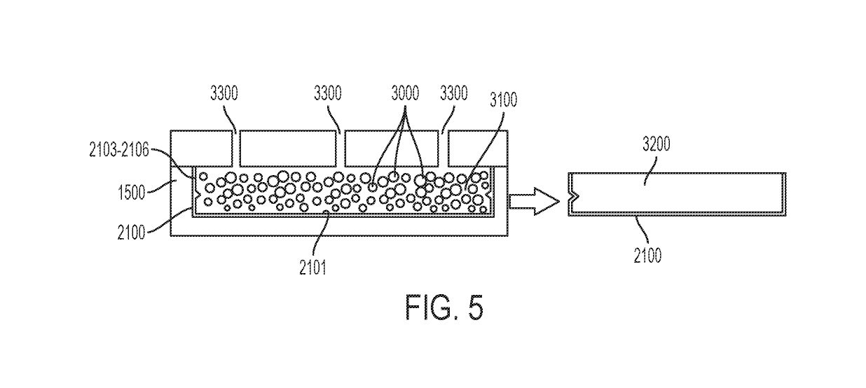

Referring now to FIG. 5, a process of the present invention is shown for the manufacture of pad 10 as an integral unit comprising shell 2100 and foam member 3200. In this process, preferably, foam member 3200 is manufactured of expanded polystyrene (EPS) using steam as the driver, a process well known to those skilled in the art. In this process, mold 1500 secures a plastic shell 2100 prefabricated to fit within mold 1500. The shape of shell 2100 includes a top side 2101 and sides 2103-2106 consistent with the teachings of this invention. EPS beads 3000 are then placed within cavity 3100 of mold 1500. Steam is then injected through inlets 3300 to fuse beads 3000 into the predetermined shape of cavity 3100, creating foam member 3200. Preferably, the steam is injected between about 100° C. and 115° C., and more preferably at a temperature of about 100° C.

Additionally, the process may include the use of a shell having extending portions 1103a-1106a of its sides as shown and discussed above with respect to FIGS. 4(a)-(c). In this alternate process, two additional steps are included which comprise the heating of extended portions 1103a-1106a after foam member 3200 has been manufactured within cavity 3100, and then such heated portions 1103a-1106a are folded over the edges of foam member 3200 to further retaining foam member 3200 within shell 2100.

In either manufacturing embodiment process, foam member 3200 is preferably permitted to dry before removing from mold 1500. This permits all the wet steam to evaporate and serves to stabilize and strengthen foam member 3200 and prevents it from warping or sagging. Thus, upon removal of shell 2100 and foam member 3200, the composite pad 10 is a solid and stable unit.

If desirable, an insecticide, termiticide and/or rodenticide may be injected among EPS beads 3000 prior to injection of steam so that such is infused within foam member 3200 when the process is completed.

Furthermore, other type foam sources may be used such as extruded polystyrene (XPS) or polyisocyanurate (ISO). It may also be preferable in certain instances to use polyurethane if it is desirable to have an open cell foam structure. In such event polyurethane may be used with a light weight concrete so that the concrete saturates the open cells of the foam. If a closed cell foam structure is preferred it may be advantageous to use polyethylene.

Having thus described in detail a preferred selection of embodiments of the present invention, it is to be appreciated and will be apparent to those skilled in the art that many physical changes could be made in the apparatus without altering the inventive concepts and principles embodied therein. The present embodiments are therefore to be considered in all respects as illustrative and not restrictive, the scope of the invention being indicated by the appended claims rather than by the foregoing description, and all changes which come within the meaning and range of equivalency of the claims are therefore to be embraced therein

This written description provides specific details and processing conditions in order to provide a thorough description of embodiments of the disclosure. However, a person of ordinary skill in the art will understand that the embodiments of the disclosure may be practiced without employing these specific details. Indeed, the embodiments of the disclosure may be practiced in conjunction with conventional techniques employed in the industry.

Furthermore, characteristics and advantages of the present disclosure and additional features and benefits will be readily apparent to those skilled in the art upon consideration of the detailed description of exemplary embodiments of the present disclosure and referring to the accompanying figures. It should be understood that the description herein and appended drawings, being of exemplary embodiments, is not intended to limit the claims of this patent or any patent or patent application claiming priority hereto. On the contrary, the intention is to cover all modifications, equivalents and alternatives falling within the spirit and scope of the claims. Many changes may be made to the particular embodiments and details disclosed herein without departing from such spirit and scope.

As used herein, the terms “disclosure”, “present disclosure,” “present invention” and variations thereof are not intended to mean every possible embodiment encompassed by this disclosure or any particular claim(s).

Certain terms are used herein and in the appended claims to refer to particular components. As one skilled in the art will appreciate, different persons may refer to a component by different names. This disclosure does not intend to distinguish between components that differ in name but not function. Also, the terms “including,” “having,” and “comprising” are used herein and in the appended claims in an open-ended fashion, and thus should be interpreted to mean “including, but not limited to . . . .” Further, reference herein and in the appended claims to components and aspects in a singular tense does not necessarily limit the present disclosure or appended claims to only one such component or aspect, but should be interpreted generally to mean one or more, as may be suitable and desirable in each particular instance.

All ranges disclosed herein are inclusive of the endpoints, and the endpoints are independently combinable with each other.

The suffix “(s)” as used herein is intended to include both the singular and the plural of the term that it modifies, thereby including at least one of that term.

The use of the terms “a,” “an,” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another.

What is claimed is:

1. A support pad comprising:
a shell member comprising a top side, having a top surface and a bottom surface, and a plurality of descending sides attached along one edge of each descending side to said top side, each descending side having an interior surface and an exterior surface so as to form a cavity below the bottom surface of the top side and the interior surfaces of the descending sides;
at least one protrusion member extending from the bottom surface of the top side into the cavity; and
a core member having a top surface, a bottom surface, and a plurality of side surfaces,
wherein said core member is affixed within the cavity by said protrusion member.

2. The support pad according to claim 1 wherein said core member has a cuboid shape.

3. The support pad according to claim 1 wherein the core member is shaped to provide a gap between at least one interior surface of a descending side and at least one side surface of said core member.

4. The support pad according to claim 1 further comprising an adhesive between the bottom surface of the top side and the top surface of said core member to adhere said core member within the cavity.

5. The support pad according to claim 1 wherein at least one descending side includes an indention.

6. The support pad according to claim 1 wherein at least one descending side includes at least one rib.

7. The support pad according to claim 1 wherein said core member comprises foam.

8. The support pad according to claim 7 wherein said foam is made from polystyrene

9. The support pad according to claim 1 wherein said core member includes a protective layer attached to the bottom surface of said core member.

10. The support pad according to claim 1 wherein said core member includes an insecticide.

11. The support pad according to claim 1 wherein said core member includes a termiticide.

12. The support pad according to claim 1 wherein said core member includes a rodenticide.

13. The support pad according to claim 1 wherein said core member includes an insecticide infused within said core member.

14. The support pad according to claim 1 wherein said core member includes a termiticide infused within said core member.

15. The support pad according to claim 1 wherein said core member includes a rodenticide infused within said core member.

16. A support pad comprising:
a shell member comprising a top side, having a top surface and a bottom surface, and a plurality of descending sides attached along one edge of each descending side to said top side, each descending side having an interior surface and an exterior surface so as to form a cavity below the bottom surface of the top side and the interior surfaces of the descending sides;
at least one protrusion member extending from the bottom surface of the top side into the cavity; and
a foam member having a top surface, a bottom surface, and a plurality of side surfaces,
wherein said cuboid is affixed within the cavity by said protrusion member and said cuboid is shaped to provide a gap between at least one interior surface of a descending side and at least one side surface of said cuboid, and wherein at least one descending side includes an indention.

17. The support pad according to claim 16 wherein at least one descending side includes at least one rib.

18. The support pad according to claim 16 wherein said foam member includes a protective layer attached to the bottom surface of said cuboid.

19. The support pad according to claim 16 wherein said foam member includes an insecticide.

20. The support pad according to claim 16 wherein said foam member includes a termiticide.

21. The support pad according to claim 16 wherein said foam member includes a rodenticide.

22. A support pad comprising:
a shell member comprising a top side, having a top surface and a bottom surface, and a plurality of descending sides attached along one edge of each descending side to said top side, each descending side having an interior surface and an exterior surface so as to form a cavity below the bottom surface of the top side and the interior surfaces of the descending sides;
at least one protrusion member extending from the bottom surface of the top side into the cavity;
a foam cuboid having a top surface, a bottom surface, and a plurality of side surfaces;
an adhesive between the bottom surface of the top side and the top surface of said cuboid to adhere said cuboid within the cavity; and
at least one of said descending sides includes at least one rib,
wherein said cuboid is further affixed within the cavity by said protrusion member.

23. The support pad according to claim 20 wherein said cuboid is shaped to provide a gap between at least one interior surface of a descending side and at least one side surface of said cuboid.

24. A support pad comprising:
a shell member comprising a top side, having a top surface and a bottom surface, and a plurality of descending sides attached along one edge of each descending side to said top side, each descending side having an interior surface and an exterior surface so as to form a cavity below the bottom surface of the top side and the interior surfaces of the descending sides;
at least one protrusion member extending from the bottom surface of the top side into the cavity; and
a foam cuboid having a top surface, a bottom surface, and a plurality of side surfaces,
wherein said cuboid is affixed within the cavity by said protrusion member and wherein a portion of each descending side extends below the bottom surface of the cuboid so that said portion of each descending edge may by folded around the edge of said cuboid formed by the bottom surface and the side surfaces of said cuboid.

25. The support pad according to claim 24 wherein said cuboid is shaped to provide a gap between at least one interior surface of a descending side and at least one side surface of said cuboid.

26. The support pad according to claim 25 wherein said cuboid includes an insecticide infused within the cuboid.

27. The support pad according to claim 25 wherein said cuboid includes a termiticide infused within the cuboid.

28. The support pad according to claim 25 wherein said cuboid includes a rodenticide infused within the cuboid.

29. A method for manufacturing a supporting pad comprising the steps of:
(a) forming a shell member comprising a top side and having a top surface and a bottom surface, and a plurality of descending sides attached along one edge of each descending side to said top side, each descending side having an interior surface and an exterior surface forming a cavity below the bottom surface of the top side and the interior surfaces of the descending sides; and
(b) forming a foam member within said shell member by source material selected from the group consisting of expanded polystyrene, extruded polystyrene, polyisocyanurate, polyurethane, or polyethylene.

30. The method for manufacturing according to claim 29 wherein the foam member has a cuboid shape.

31. The method for manufacturing according to claim 29 wherein step (a) is performed prior to step (b).

32. The method for manufacturing according to claim 29 wherein step (a) and step (b) are performed concurrently.

33. The method for manufacturing according to claim 29 wherein the formation of the foam member is created using steam at a temperature of between about 100° C. and 115° C.

34. The method for manufacturing according to claim 33 wherein the formation of the foam member is created using steam at a temperature of about 100° C.

35. The method for manufacturing according to claim 29 further comprising the steps of:
(c) heating a portion of at least one descending side extending below the bottom surface of the foam member, and
(d) folding said extended heated portion around the edge of the foam member at its bottom surface to further retain the foam member within the cavity.
